(19) United States
(12) Patent Application Publication
(10) Pub. No.: US 2010/0015581 A1
(43) Pub. Date: Jan. 21, 2010

(54) Language arts game

(76) Inventor: Semina DeLaurentis, Torrington, CT (US)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 12/460,301

(22) Filed: Jul. 15, 2009

Related U.S. Application Data
(60) Provisional application No. 61/135,127, filed on Jul. 16, 2008.

(51) Int. Cl. G09B 19/00

(52) U.S. Cl. 434/156

(57) ABSTRACT

An interactive live game, computer program game, television game, television game show, Internet game and Internet game show for all ages. The game in all forms is based on language arts, testing and teaching the players' knowledge in the use of written and oral language. All aspects of language arts, including but not limited to punctuation, spelling and grammar, are determined, found or corrected by individual teams. The game may be utilized in other educational fields, such as science or mathematics, or may be utilized for example in concepts of artificial intelligence, voice recognition and the like.

### CROSS REFERENCE TO RELATED APPLICATION

Reference is made to and priority claimed from U.S. provisional application Ser. No. 61/135,127, filed Jul. 16, 2008, entitled LANGUAGE ARTS GAME, which is incorporated herein by reference.

### BACKGROUND OF THE INVENTION

1. Technical Field

The concept of the present invention pertains to the field of educational games. More particularly, the concept of the present invention pertains to an interactive live game, computer program game, television game, television game show, Internet game and Internet game show for all ages. The game in all forms is based on language arts, testing and teaching the players' knowledge in the use of written and oral language. All aspects of language arts, including but not limited to punctuation, spelling and grammar, are determined, found or corrected by individual teams. It is not intended that the concept of the present invention be limited to language arts and may be utilized in other educational fields, such as science or mathematics, or may be utilized for example in concepts of artificial intelligence, voice recognition and the like.

### DISCLOSURE OF INVENTION

The concept of the present invention provides a new interactive educational game for testing and teaching written and oral language skills.

The purpose of the present invention, which will be described subsequently in greater detail, is to provide a new interactive educational game comprising novel features that result in improving the written and oral language skills of its players.

To this end, in some embodiments the present invention generally comprises two or more players or teams, game cards (e.g. “Gain-a-Turn Card” or “Immunity Card”), scoring means, game board, timer, and document page having sentences and/or paragraphs containing incorrect spelling, grammar, punctuation, etc.

In some embodiments, the game is an interactive game played in a game board fashion with teams or individual players and a host who monitors the game play. Game cards, scoring means, game board, timer, and document page having sentences and/or paragraphs containing incorrect spelling, grammar, punctuation, etc. are tangible aspects of the game.

In some embodiments, the game is a computer software game for individual players. The rules of the game are the same as in the interactive game, however, game cards, scoring means, game board, timer, and document page having sentences and/or paragraphs containing incorrect spelling, grammar, punctuation, etc. are all displayed on a computer screen, or other device including but not limited to a portable game unit or wireless communication device.

In some embodiments, the game is an interactive television game, television game show, Internet game or Internet game show with teams or individual players and a host who monitors the game play. The rules of the game are the same as in the first embodiment, however, game cards, scoring means, game board, timer, and document page having sentences and/or paragraphs containing incorrect spelling, grammar, punctuation, etc. are larger in scale so as to accommodate a viewing audience. This embodiment may also be utilized in a classroom or other group instructional setting.

In accordance with a first broad aspect of the invention, an educational game comprises a document page containing errors requiring correction by the players; a plurality of game pieces, at least some of which are for correcting the plurality of errors in the document page; a board for displaying the game pieces, wherein the document page, game pieces and board are configured to provide removable placement of the game pieces on the document page and board; and means for displaying and selecting available points or other game functions.

In some embodiments, the educational game is a language arts game. In some embodiments, the document page comprises at least two sentences containing a plurality of grammar errors. In some embodiments, the document page comprises at least two sentences containing a plurality of grammar errors.

In some embodiments, the other game functions include lose-a-turn, gain-a-turn, double-points and pick-a-question. In some embodiments, the at least one of the game pieces, the board and the document page have adhesive, magnetic or other means for removably affixing the game pieces to the board and document page. In some embodiments, the educational game is a mathematical game or a science game. In some embodiments, the education game further comprises a plurality of cards each having a specific game function. In some embodiments, further comprises a plurality of correct answer tokens.

In accordance with a second broad aspect of the invention, a method of playing an educational game by at least two players comprises creating a document page having a plurality of errors requiring correction by the players; creating a plurality of game pieces, at least some of which are for correcting the plurality of errors in the document page; providing a board for displaying the game pieces, wherein the document page, game pieces, and board are configured to provide removable placement of the game pieces on the document page and board; providing means for displaying and selecting available points or other game functions; determining an order of players for each round of play; commencing the first round of play by a first player engaging the means for displaying and selecting in order to determine a number of points associated with a correct answer or to determine another game function; if engaging the means for displaying and selecting results in the selection of the number of points, the first player selects one of the game pieces and places the selected game piece on an area of the document page which the first player believes would be corrected by the selected game piece; if the first player is correct, the first player is awarded the number of points displayed; if the first player is not correct, each subsequent player is allowed to attempt to correct the error until the error is properly corrected; the subsequent player who properly corrects the error is awarded the first player's number of points; if none of the subsequent players is correct, the correct answer is revealed without awarding points to any of the players and another round of play is started; if engaging the means for displaying and selecting results in the selection of another game function, the first player carries out the function selected; commencing a subsequent round of play after the first round has ended using the same method as the first round of play until each player has a turn; continuing rounds of play until game play expires; tallying the number of points earned by each player during each round; and determining a winner by establishing the player having the highest number of points.

In some embodiments, the educational game is a language arts game. In some embodiments, the document page comprises at least two sentences containing a plurality of grammar errors. In some embodiments, creating the document page having the plurality of grammar errors comprises removing punctuation, misspelling words, omitting capitalization, providing incorrect homonyms, or providing incorrect verb tenses. In some embodiments, the other game functions include lose-a-turn, gain-a-turn, double-points and pick-a-question. In some embodiments, if the player selects the pick-a-question function of the means for displaying and selecting, the player is asked a question or series of questions related to the document page; if the player answers correctly, the player is awarded an immunity card, which allows the player to receive a second chance at answering an incorrectly answered question or placing an incorrectly placed game piece at a later time in the game; if the player answers incorrectly, a subsequent player is given an opportunity to answer; if the subsequent player is correct, the subsequent player is awarded the immunity card; if none of the subsequent players is correct, the correct answer is revealed without awarding the immunity card to any of the players and another round of play is started. In some embodiments, the educational game is a mathematical game or a science game. In some embodiments, the method further comprises determining a set period of time for game play in order to establish an end time. In some embodiments, the method further comprises determining a set period of time for each round of play. In some embodiments, a high-speed round is played using a similar format to the game round but in which each player is provided with identical document pages and game pieces and each player simultaneously is instructed to correct as many errors as possible in the document page during a shortened period of time. In some embodiments, the game is televised or transmitted over the Internet.

In accordance with a third broad aspect of the invention, a computer readable medium encoded with a computer program for performing a method of playing an educational game comprises creating a document page having a plurality of errors requiring correction to be displayed on a screen of an electronic device; creating a plurality of game pieces, at least some of which are for correcting the plurality of errors in the document page; providing an area for displaying the game pieces on the screen; providing means for displaying and selecting available points or other game functions; commencing game play by the player electronically engaging the means for determining and selecting in order to determine a number of points associated with a correct answer or to determine another game function; if engaging the means for displaying and selecting results in the selection of the a number of points, the first player selects one of the game pieces and places the selected game piece on an area of the document page which the first player believes would be corrected by the selected game piece, wherein the placing of the game pieces is carried out using a mouse, a stylus, arrow keys or other data entry means; if the player is correct, the player is awarded the number of points displayed; if the player is not correct, the round ends, no points are awarded and another round of play is started; if engaging the means for displaying and selecting results in the selection of the another game function, the player carries out the function selected; commencing a subsequent round of play after the first round has ended using the same method as the first round of play; continuing rounds of play until the player ends the game.

It is to be understood that the invention is not intended to be limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. Moreover, the scope of the invention is not intended to be limited to any particular implementation using technology now known or developed in the future.

### BRIEF DESCRIPTION OF THE DRAWINGS

The above and other features and advantages of the concept of the invention will become apparent from a consideration of the subsequent detailed description presented in connection with accompanying drawings, in which:

FIG. 1 shows an overview of major components of the game.

FIG. 2 shows a game wheel.

FIG. 3 shows a document page.

FIG. 4 shows a Pick ‘n’ Choose Board.

FIG. 5 shows a document page following correction by a player or team.

FIG. 6 shows a listing of the types of corrections to be made during the course of game play.

FIG. 7 shows Gain-a-Turn and Immunity Cards.

FIG. 8 shows correct answer tokens.

FIG. 9 shows an example of a Pick ‘n’ Choose Board having Editor's Choice Questions.

FIG. 10 shows an Editor's Choice Question.

FIG. 11 shows an embodiment of the invention as presented on a computer.

FIGS. 12a-12e show subsequent pages of a set of instructions for an embodiment of the invention.

FIG. 13 shows a set of instructions for an alternative embodiment of the invention.

FIG. 14 shows a set of instructions for another alternative embodiment of the invention.

### DETAILED DESCRIPTION

The concept of the invention involves or is related to an educational game comprising all aspects of language arts, including but not limited to punctuation, spelling and grammar. For the purposes of illustration, the functions of the game will become evident from the following detailed disclosures for certain embodiments. The first example to be illustrated and the one to be illustrated in the greatest detail is the embodiment in which the game is used in a classroom or other group instructional setting.

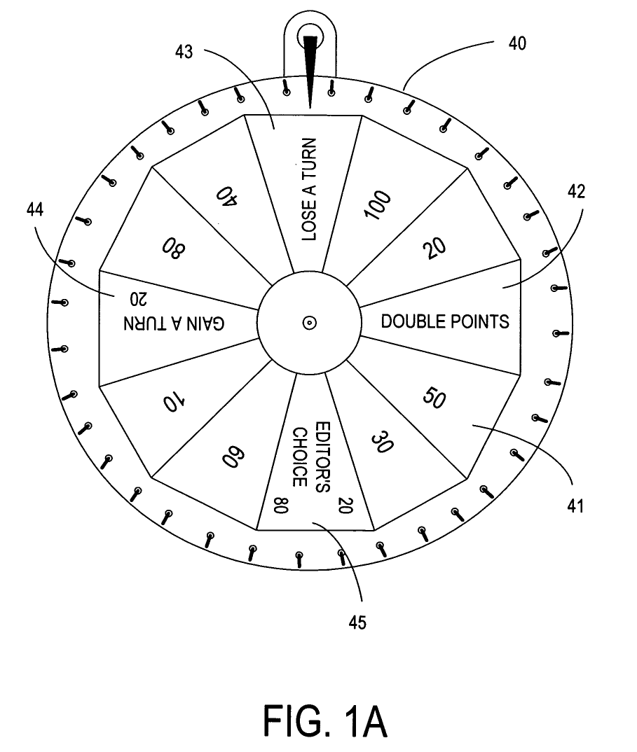

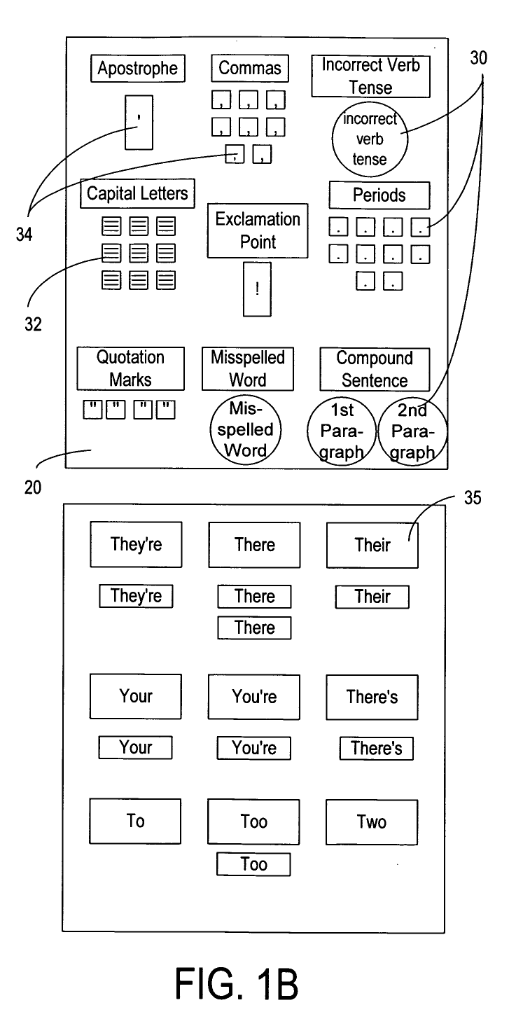

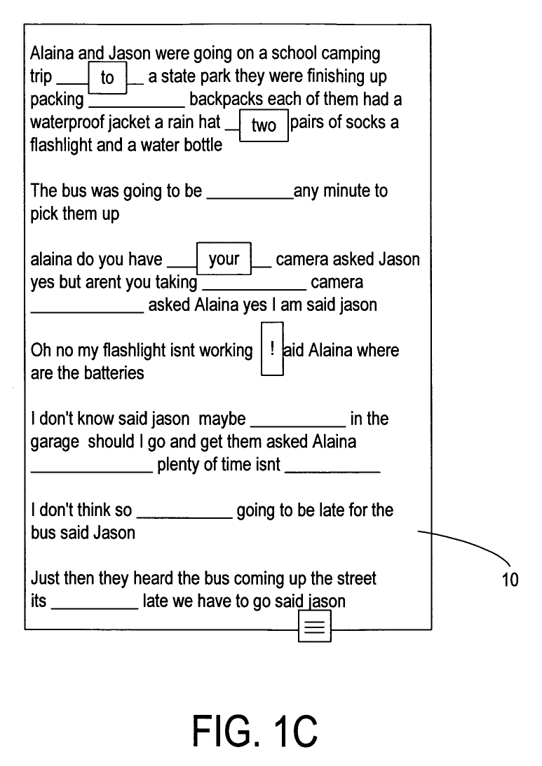

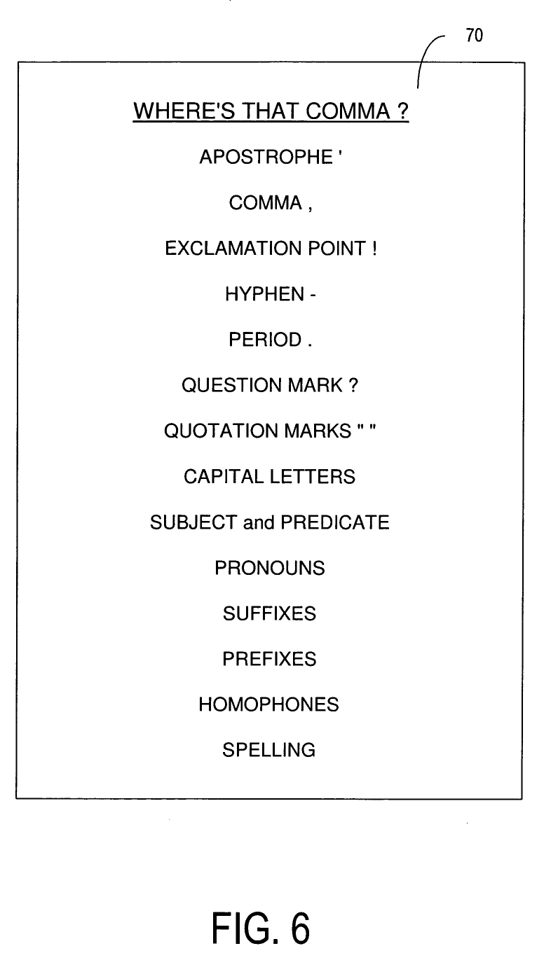

Referring now to FIG. 1, an embodiment of the concept of the invention is shown in which the game is used in a classroom or other group instructional setting. A document page 10 is displayed comprising sentences in paragraph story form, though the invention is not limited to this form. The sentences contain spelling, grammar and/or punctuation errors, and may also contain other language arts elements, such as homonyms. FIG. 6 shows a listing of the types of corrections that may be made during the course of game play.

Also displayed is a Pick ‘n’ Choose Board 20, which may have magnetic or other adhesive properties. Game pieces 30 are removably affixed to the board 20 via magnetic, adhesive or other connecting means. Various categories are represented on the board 20 and have corresponding game pieces, such as homonyms 35, punctuation marks 34, and capital letters 32. During game play, which will be disclosed in detail herein, game pieces are placed on the document page 10, which may have magnetic or other adhesive properties.

Further displayed is a game wheel 40. The game wheel 40 comprises various sections that contain points 41, or other game functions such as Lose a Turn 43, Gain a Turn 44, Double Points 42, and Editor's Choice 45. Other means for displaying and selecting points or other game functions may also be used, such as multi-sided dice.

It is to be understood that the aforementioned devices may include other features known in the art that do not form a part of the underlying invention. Accordingly, the scope of the invention is not intended to be limited to any particular implementation using technology now known or developed in the future.

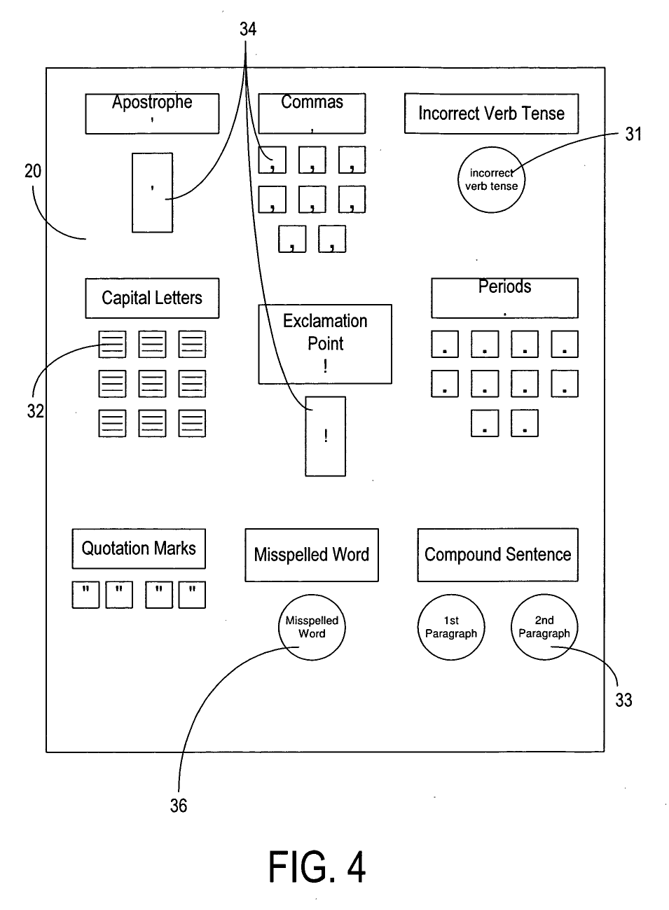

Prior to the start of the game, a document page 10 is created using any story, document or collection of sentences. The document page 10 may be created on a dry-erase board, a printed page of paper, a chalkboard, a whiteboard, or any other similar means. After all the punctuation is removed and various grammatical errors are included in the document page 10, the Pick ‘n’ Choose Board 20 is created based on the errors in the document page 10; i.e., the document page 10 may require three question marks, 7 commas, 4 capital letters, and may have 2 misspelled words, 1 incorrect verb tense, etc., therefore these are added to the board as individual game pieces 30. For example, a single comma would become one game piece, or “incorrect verb tense” would be written on a single game piece, etc.; see FIG. 4. The Pick ‘n Choose Board 20 may also include extra game pieces that do not correspond to the errors in the document such that the players are shown more correcting options than necessary, thereby making the game more difficult.

Game play may begin with an explanation of the rules by the game host or mediator. The game host keeps the game moving and monitors the time. The game host also keeps the corrected document corresponding to the document page 10 used during game play; the corrected document has the correct punctuation, grammar, etc. for reference and correct answers.

The game may be played with individual players or teams. For the purposes of illustration, team play will be described herein; this is only one embodiment, however, and is not intended to be limiting. Each team should have an equal number of players. Each team may have up to twelve members, and of the twelve members, one is elected the team captain. The captain speaks for the team when a team answer is solicited and also assigns team players to certain game tasks. The captain is also in charge of keeping any cards (e.g. Gain a Turn Card 50 or Immunity Card 60) for the team until he determines that they should be used. Each team selects a name, which is created by the members of the team. Team members are given a number, which determines in what order they play. The order of game play begins with the captain, and then the captain randomly selects numbers corresponding to team members until all members on the team have played. If the game stops or takes a break, the game resumes where the numbers left off.

Scoring may be kept by the game host or a producer (in the television or Internet game show embodiment). Points are cumulative to the end of the game.

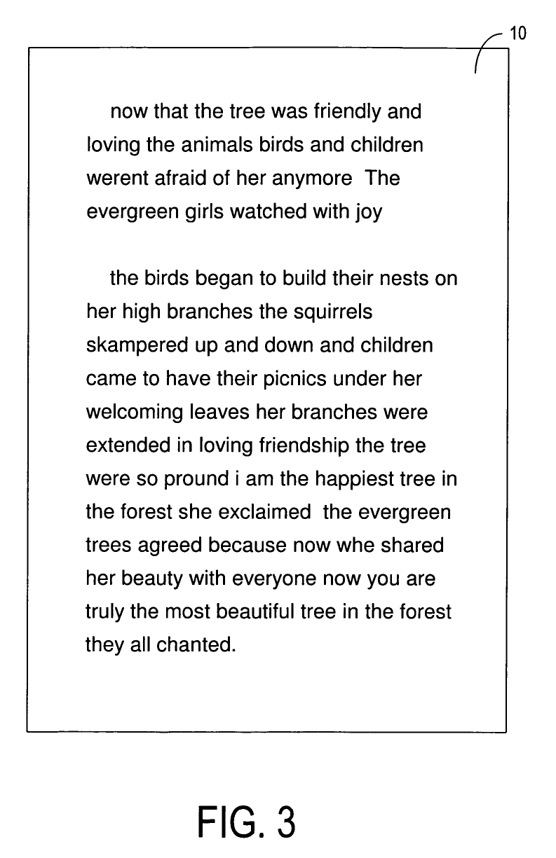

Once the teams are ready to begin game play, a document page 10, such as is shown in FIG. 3, is displayed. All punctuation is removed from the document page 10; words may be misspelled and incorrect grammar also may be used. Other language arts elements may be present as well, such as homonyms.

A Pick ‘n’ Choose Board 20, such as is shown in FIG. 4, having all the possible punctuation marks and other choices for the document page 10, is displayed. The game host may read the document page 10 aloud. Each team is given two minutes to review the document page 10 and the Pick ‘n’ Choose Board 20 to determine where certain punctuation marks should be placed, where other corrections are needed, and where any other language arts elements shown on the Pick ‘n’ Choose Board 20 may be utilized. It is not intended that the review time be limited to two minutes; other suitable time limits may be utilized, for example to accommodate players of differing ages, education and mental capacity.

After the review period is complete, the game begins. The team captain for each team pulls a number out of a bowl or other container from the game host. The numbers may be written on pieces of paper, or may be any other numbering means. The captain holding the highest number goes first and then determines the order of game play for each individual player on his team.

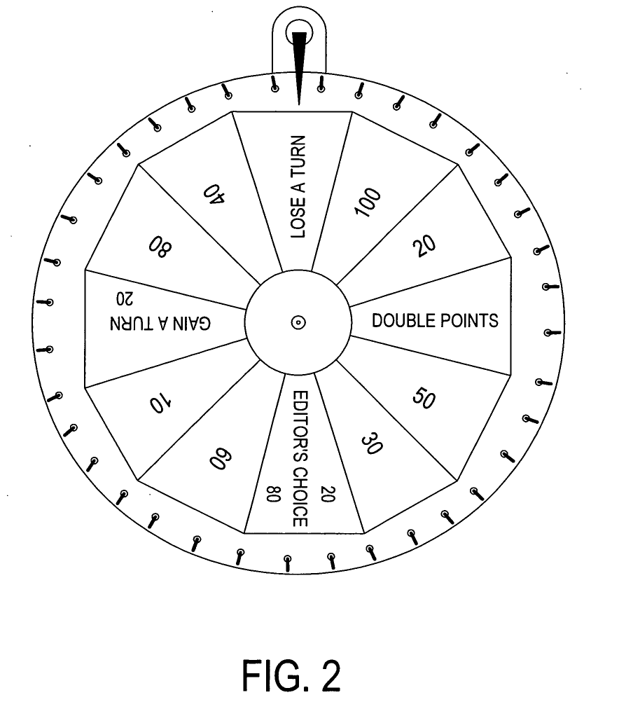

The first player spins the game wheel 40, as shown in FIG. 2. The game wheel 40 may be spun manually, or by automatic means, such as a button or other electronic means. This process may be accompanied by music for entertainment purposes. The scope of the invention is not intended to be limited to any particular implementation using technology now known or developed in the future.

Available points on the game wheel 40 may be e.g. twenty (20), forty (40), fifty (50), etc., and any suitable incremental values may be used. Double Points 42 affords a player double points if he is successful in his turn; the player pulls a number (20, 40 or 60) out of a basket or other container and receives double that number of points. Gain a Turn 44 affords a player a Gain a Turn Card 50 if he is successful in his turn; the player also receives twenty points. A Gain a Turn Card 50 may be used to gain an extra turn immediately upon completion of a successful turn, or can be used at another strategic time during the game, such as when landing on Lose a Turn 43. Gain a Turn Cards 50 can only be redeemed one at a time and not consecutively per team round. Lose a Turn 43 forces the playing team to lose its turn immediately to another team.

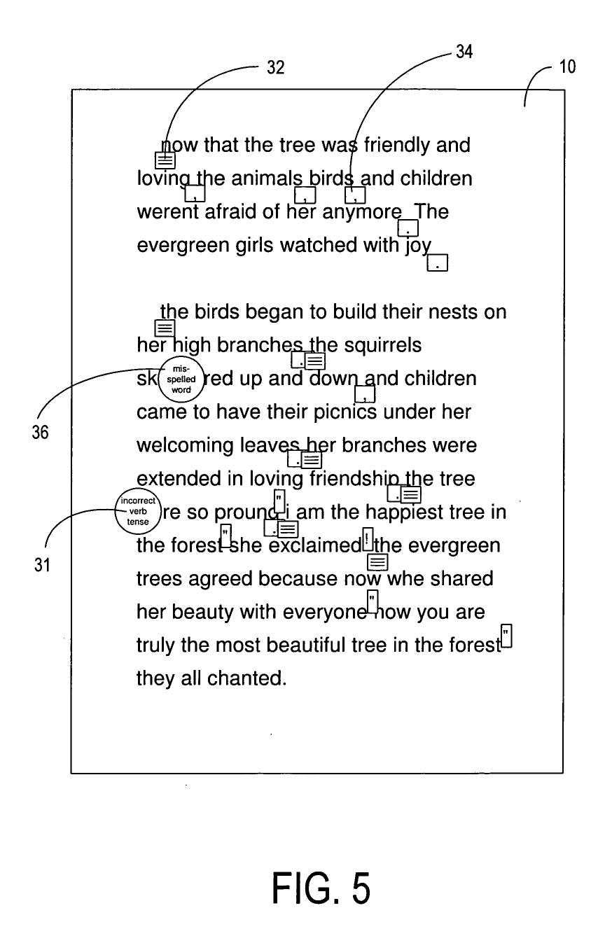

After landing on a section of the game wheel 40, the player plays for the number of points 41 shown in that section, or does what the section displays, such as Gain a Turn 44. The player has eighteen seconds to take any punctuation mark 34 game piece from the Pick ‘n’ Choose Board 20, as shown in FIG. 4, and place it on the document page 10 in the grammatically correct location, as shown in FIG. 5. This is considered to be regular play.

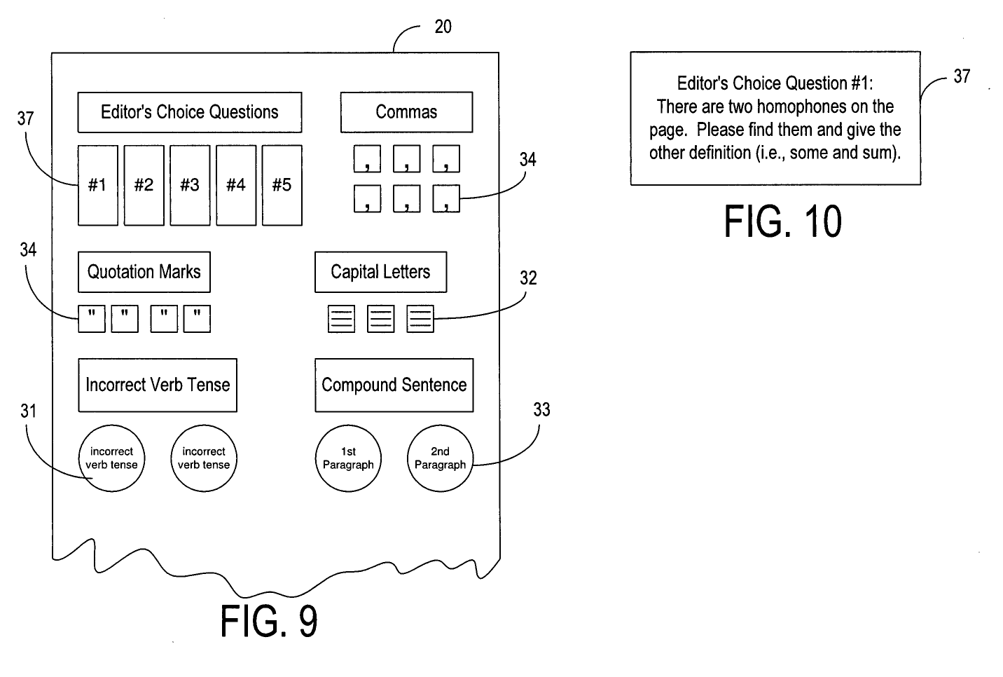

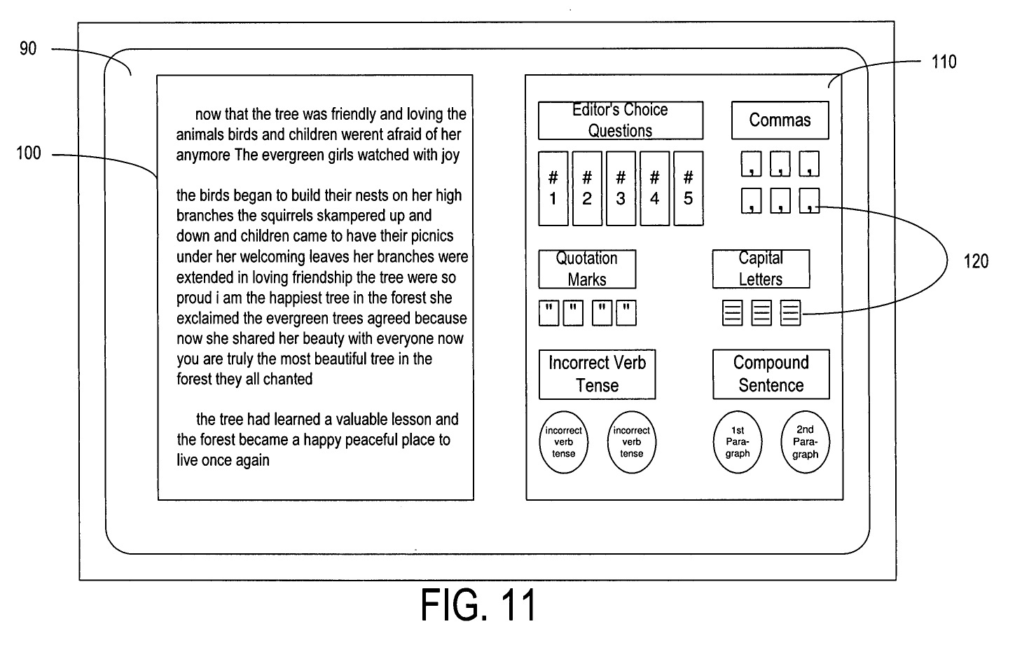

If the player lands on Editor's Choice 45, the player may choose to take any punctuation mark 34 game piece from the Pick ‘n’ Choose Board 20 and place it on the document page 10 in the grammatically correct location for forty points, or the player may choose an Editor's Choice Question 37 from the Pick ‘n’ Choose Board 20, as shown in FIG. 9, for eighty points. The Editor's Choice Questions 37 are created and based on the content of the document page 10, and are unknown until asked. An example of an Editor's Choice Question 37 is shown in FIG. 10. The player is given thirty seconds to answer the Editor's Choice Question 37 or make the correction required by the Editor's Choice Question 37. If the player answers the Editor's Choice Question 37 correctly, he is awarded an Immunity Card 60. If all Editor's Choice Questions 37 have already been chosen and answered during the game and a player lands on Editor's Choice 45, the player plays a regular round for twenty points.

Whether playing for points 41 or answering Editor's Choice Questions 37, the player must place the correction or answer the question himself; the team may not give the answer. However, the team may offer assistance by saying “yes,” “no,” “up,” “down,” etc. to guide the player. If the player places/answers correctly, then the next play/spin goes to the next player on the next team, not the team that just correctly placed/answered. For purposes of illustration in this example, the first team shall be called team A, and the next team shall be called team B. Game play continues in this alternating team fashion until a player places/answers incorrectly.

If a player on team A incorrectly places/answers, the next team, team B, is given ten seconds to correctly place/answer. The captain should speak for the team or designate a person to place/answer.

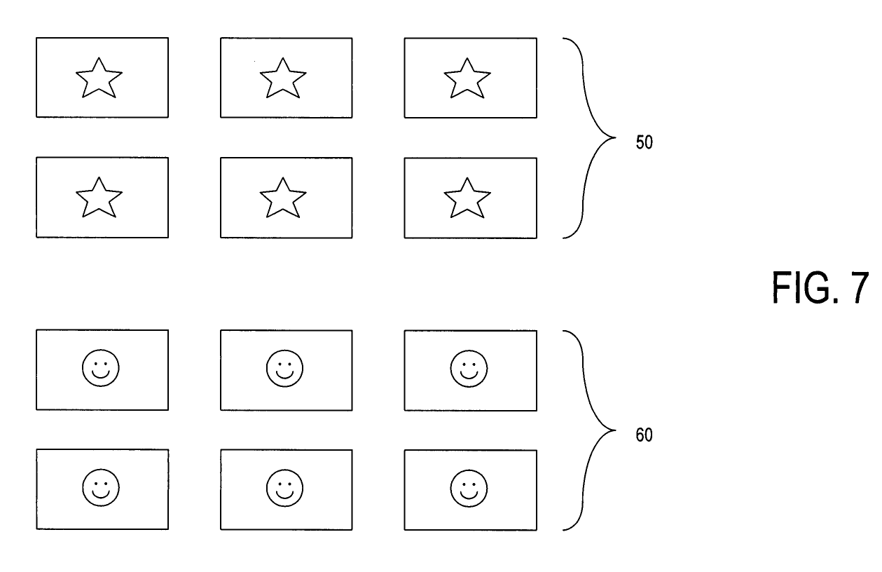

If team B places/answers correctly, team B is awarded the number of points 41 (or other award, such as Gain a Turn 44) for which team A was originally playing. If team A made an error on an Editor's Choice Question 37 and team B answered correctly, team B is awarded an Immunity Card 60, as shown in FIG. 7. An Immunity Card 60 may be turned into the game host by a team who has incorrectly placed/answered in order to be allowed another chance to place/answer. An Immunity Card 60 may be used only once per turn.

If, however, team B places/answers incorrectly, team A is given one last chance to correctly place/answer. Team B cannot, in this situation, turn in an Immunity Card 60 to the game host in order to try to place/answer correctly again. Team A is given five seconds to accomplish a correct placement/answer, and if team A is successful, they are awarded half the original points 41. If team A had originally landed on Gain a Turn 44 on the game wheel 40, team A wins a Gain a Turn Card. If team A had originally landed on Editor's Choice 45, team A wins an Immunity Card 60.

If both teams are incorrect, the game piece 30 chosen by the player is placed back on the Pick ‘n’ Choose Board 20 by the game host. An incorrectly answered Editor's Choice Question 37 is answered by the game host. Game play then resumes in an alternating team fashion as described above.

It is to be understood that the aforementioned method may include other steps known in the art that do not form a part of the underlying invention.

Extra points may be awarded during the game. Any player that finds misspelled words on the document page 10 is awarded the number of points shown on the game wheel 40 for that turn. If the player then spells the misspelled word correctly, he is awarded forty extra points. If the player spells it incorrectly, the other team is offered the opportunity to correctly spell the word to receive the extra forty points. Also, if a player chooses quotation marks game pieces and correctly places them on the document page 10, the player is awarded forty extra points. Additionally, before the start of the game, the game host may designate which items on the Pick ‘n’ Choose Board 20 will earn extra points.

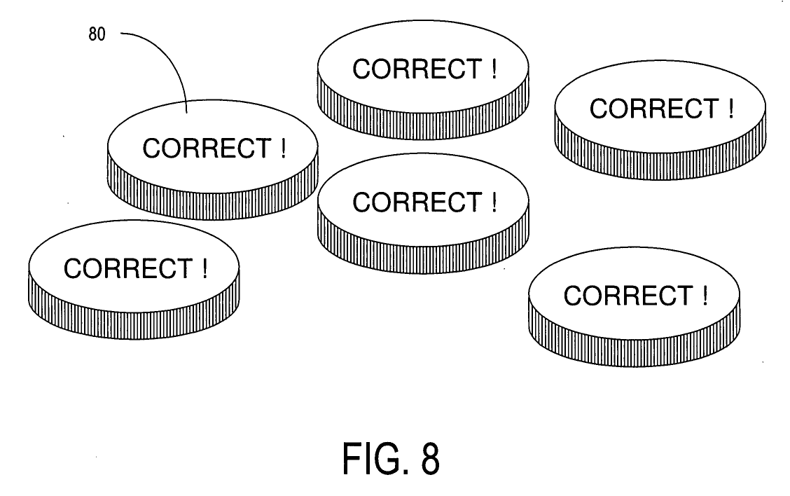

Each time a player places/answers correctly, the player may be awarded a correct answer token 80 or prize, such as a coin, plastic toy or polished stone; see FIG. 8. Each correct answer token 80 is worth one-hundred points and is turned in at the end of the game.

Lightning rounds may be played at any time or during the last part of the game. In a lightning round, identical document boards 10 and Pick ‘n’ Choose Boards 20 are prepared for each team. Each team has one minute to review the boards and then one minute to place as many game pieces 30 on the document page 10 as possible. Each correct game piece 30 is worth fifty points.

At the end of the game, the game host (or producer in the case of a television or Internet game show) tallies the points for each team to determine the winner. The team with the most points, including points earned by spinning the game wheel 40 and earned with correct answer tokens 80, wins. A team may have the most points scored on the wheel, but fewer correct answer tokens, consequently that team may have fewer points in the end. The winner is declared the “Publisher” and may then proceed to the next game, in tournament fashion. Prizes may be awarded as afforded.

It is to be understood that the steps of the procedure are not intended to be limited to that described above and may include other steps known in the art that do not form a part of the concept of the invention.

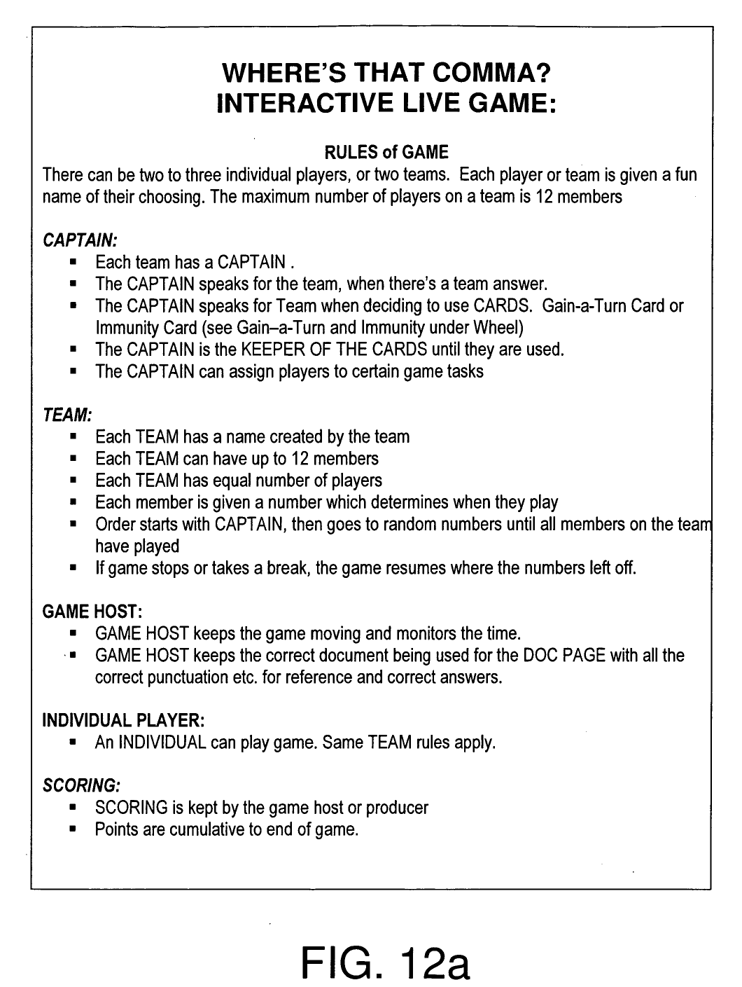

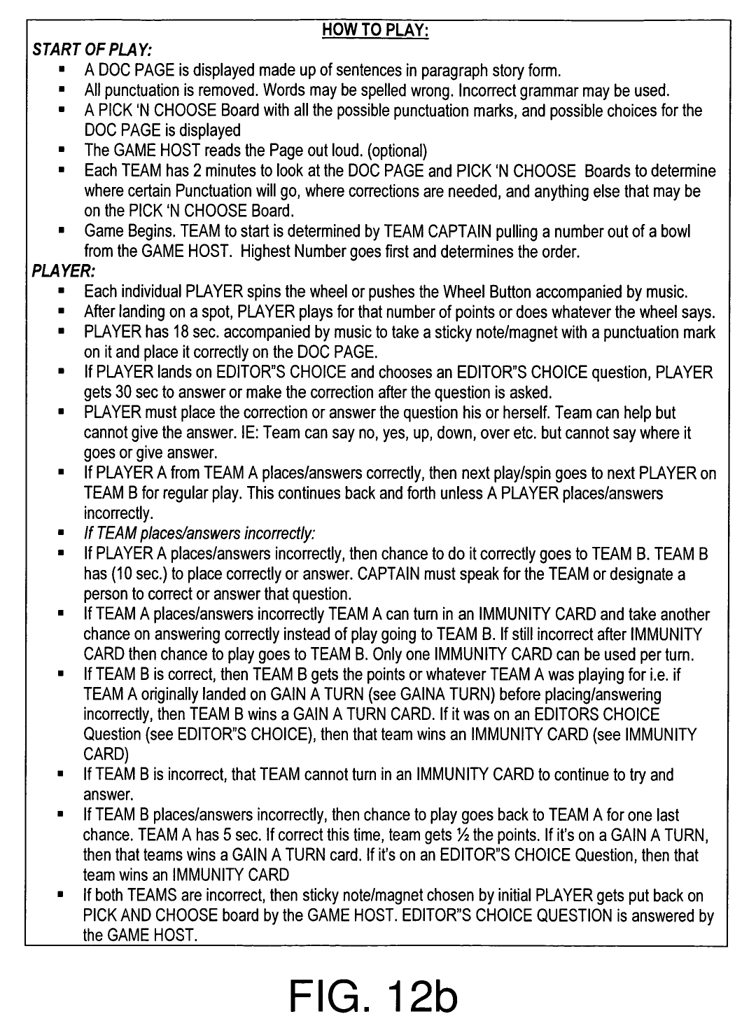

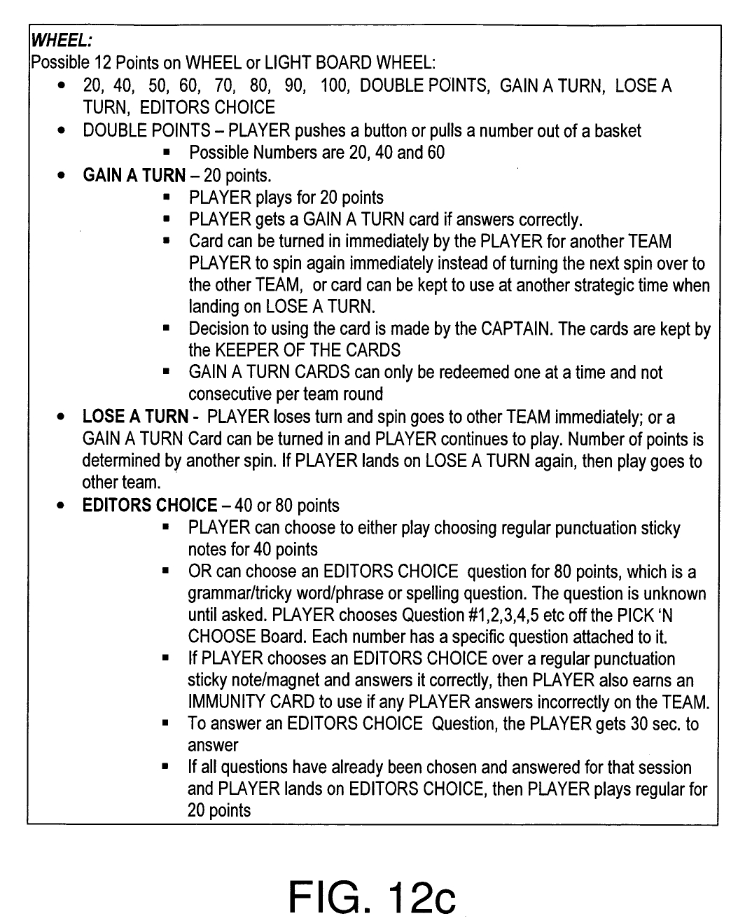

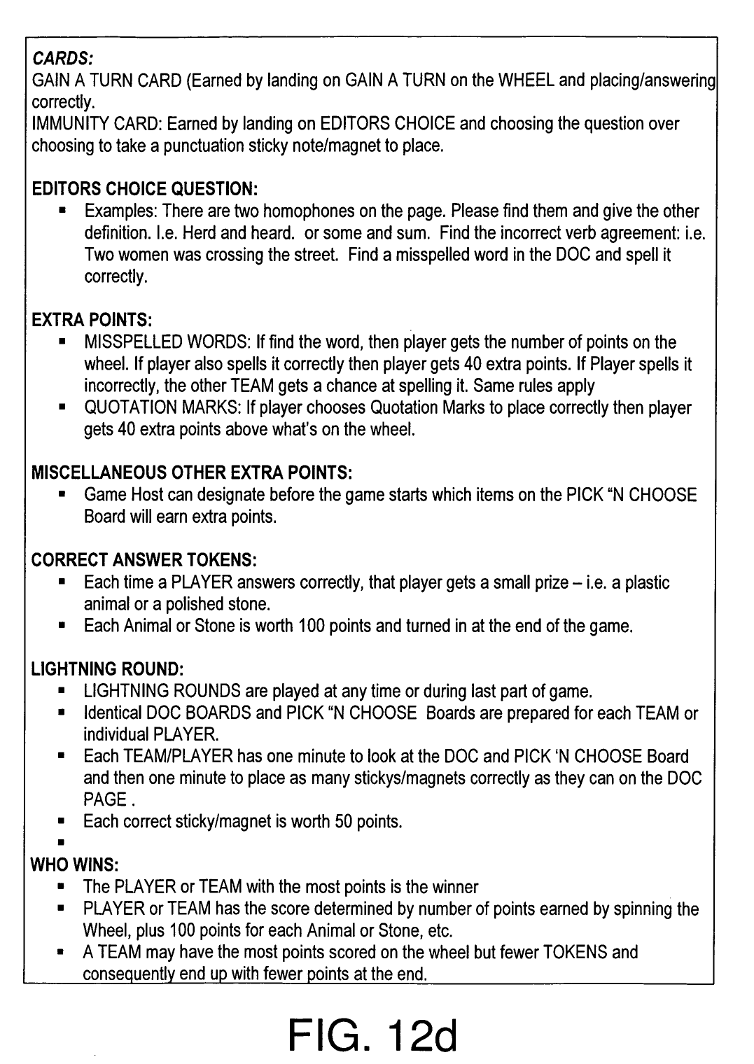

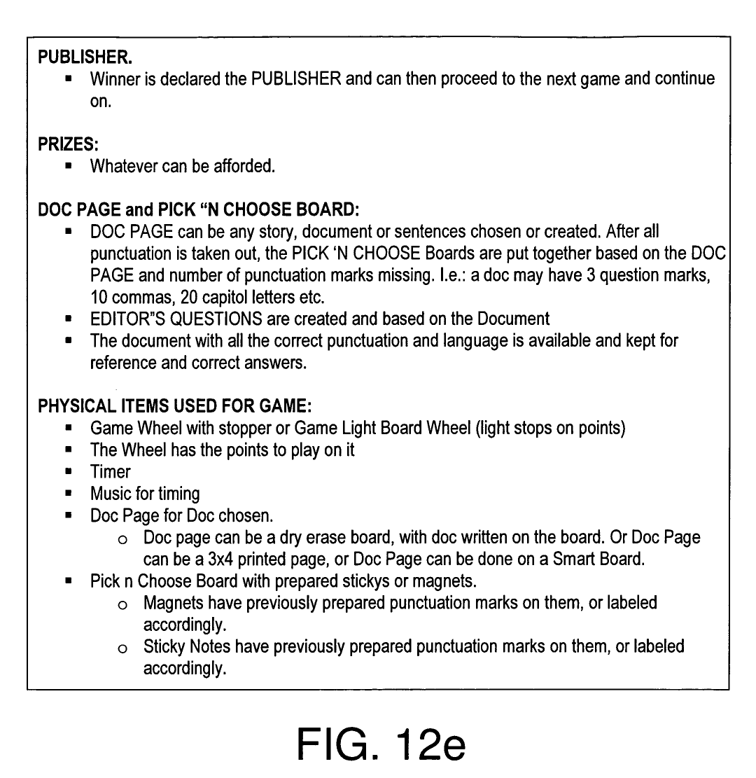

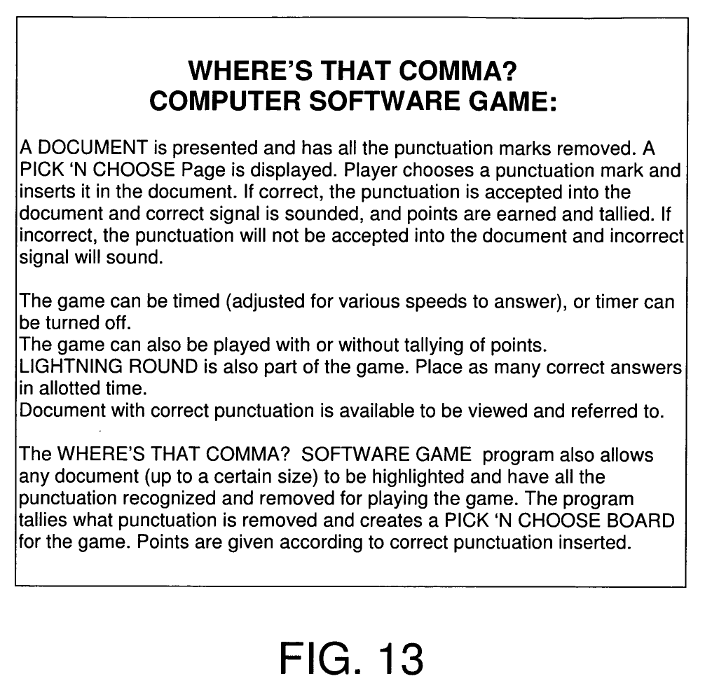

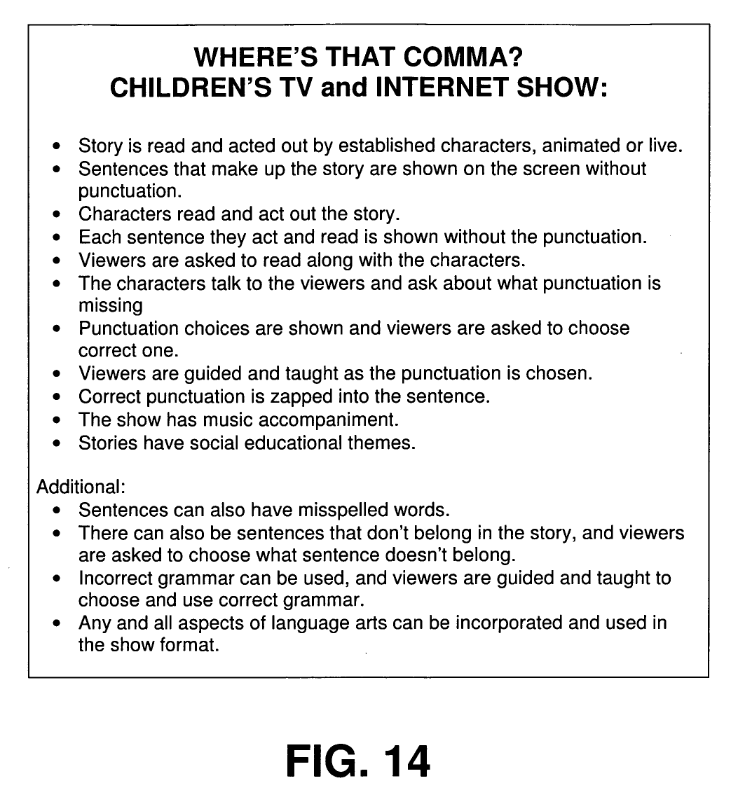

Examples of rules/instruction sheets for carrying out some embodiments of the concept of the invention are shown in FIGS. 12a-12e, 13 and 14.

The game may also be played in such a manner that the document page and Pick ‘n’ Choose Board lie flat on a surface, such as a table or desk. In such an embodiment, the game pieces may be removably placed on top of the document page and Pick ‘n’ Choose Board with or without use of adhesive, magnetic or other affixing means. In such an embodiment, a plurality of copies of the same document page, same Pick ‘n’ Choose Board and same game pieces may be distributed to a plurality of players such that each player may play along at his or her own area, such as a student's desk in a classroom setting.

The game may also be played with individual players, rather than teams, using the same rules and procedure as described above for team play.

In some embodiments, the concept of the invention provides a computer readable medium encoded with a computer program for performing the game play method described above. In this computer game embodiment, a document 100 and a Pick ‘n’ Choose page 110 are presented on a computer screen 90. The player chooses a punctuation mark 120 and inserts it into the document 100. If correct, the punctuation is accepted into the document 100 and a correct signal is sounded, then points are awarded and tallied. If incorrect, the punctuation will not be accepted into the document 100 and an incorrect signal will sound.

The game may be timed, or the timer may be disabled. The game may also be played with or without the tallying of points. A lightning round may also be played in which as many correct answers as possible are placed during an allotted time. A document having the correct punctuation is available for viewing by the player.

In addition to any preloaded documents 100, the computer game embodiment also allows any document (up to a certain size) to be highlighted and have all the punctuation recognized and removed for playing the game. The program tallies what punctuation is removed and creates a Pick ‘n’ Chose page 110 for the game. Points are given according to correct punctuation inserted.

In some embodiments, the concept of the invention is a television game, television game show, Internet game or Internet game show for children. A story may be read and acted out by established characters, which are animated characters or live actors. The sentences that comprise the story are shown on the television or computer screen without punctuation. The viewers are asked to read along with the characters. The characters talk to the viewers and ask (rhetorically) about what punctuation is missing. The viewers are guided and taught as the punctuation is chosen. The correct punctuation is added to the sentence in a visually attractive manner, such as by “zapping.” In addition to missing punctuation, the story may also contain misspelled words, sentences that do not belong in the story, incorrect grammar, or any other aspect of the language arts that may be incorporated into this educational television or Internet format. The game may also have musical accompaniment for entertainment purposes, and the stories may have social and educational themes.

It is to be understood that, unless stated otherwise herein, any of the features, characteristics, alternatives or modifications described regarding a particular embodiment herein may also be applied, used, or incorporated with any other embodiment described herein.

It is to be understood that the above-described arrangements are only illustrative of the application of the principles of the concept of the present invention. References to particular timeframes or point values may be adjusted and are not limited to those values that have been disclosed herein. Numerous modifications and alternative arrangements may be devised by those skilled in the art without departing from the scope of the present invention.

Although the invention has been described and illustrated with respect to exemplary embodiments thereof, the foregoing and various other additions and omissions may be made therein without departing from the spirit and scope of the present invention.

What is claimed is:

1. An educational game, comprising:
a document page containing errors requiring correction by the players;
a plurality of game pieces, at least some of which are for correcting the plurality of errors in the document page;
a board for displaying the game pieces, wherein the document page, game pieces and board are configured to provide removable placement of the game pieces on the document page and board; and
means for displaying and selecting available points or other game functions.

2. The educational game of claim 1, wherein the educational game is a language arts game.

3. The educational game of claim 2, wherein the document page comprises at least two sentences containing a plurality of grammar errors.

4. The educational game of claim 3, wherein the plurality of grammar errors comprises missing punctuation, misspelled words, omitted capitalization, incorrect homonyms, or incorrect verb tenses.

5. The educational game of claim 1, wherein the other game functions include lose-a-turn, gain-a-turn, double-points and pick-a-question.

6. The educational game of claim 1, wherein the at least one of the game pieces, the board and the document page have adhesive, magnetic or other means for removably affixing the game pieces to the board and document page.

7. The educational game of claim 1, wherein the educational game is a mathematical game or a science game.

8. The educational game of claim 1, further comprising a plurality of cards each having a specific game function.

9. The educational game of claim 1, further comprising a plurality of correct answer tokens.

10. A method of playing an educational game by at least two players, comprising:
creating a document page having a plurality of errors requiring correction by the players;
creating a plurality of game pieces, at least some of which are for correcting the plurality of errors in the document page;
providing a board for displaying the game pieces, wherein the document page, game pieces, and board are configured to provide removable placement of the game pieces on the document page and board;
providing means for displaying and selecting available points or other game functions;
determining an order of players for each round of play;
commencing the first round of play by a first player engaging the means for displaying and selecting in order to determine a number of points associated with a correct answer or to determine another game function;
if engaging the means for displaying and selecting results in the selection of the number of points, the first player selects one of the game pieces and places the selected game piece on an area of the document page which the first player believes would be corrected by the selected game piece;
if the first player is correct, the first player is awarded the number of points displayed;
if the first player is not correct, each subsequent player is allowed to attempt to correct the error until the error is properly corrected;
the subsequent player who properly corrects the error is awarded the first player's number of points;
if none of the subsequent players is correct, the correct answer is revealed without awarding points to any of the players and another round of play is started;
if engaging the means for displaying and selecting results in the selection of another game function, the first player carries out the function selected;
commencing a subsequent round of play after the first round has ended using the same method as the first round of play until each player has a turn;
continuing rounds of play until game play expires;
tallying the number of points earned by each player during each round; and
determining a winner by establishing the player having the highest number of points.

11. The method of claim 10, wherein the educational game is a language arts game.

12. The method of claim 11, wherein the document page comprises at least two sentences containing a plurality of grammar errors.

13. The method of claim 11, wherein creating the document page having the plurality of grammar errors comprises removing punctuation, misspelling words, omitting capitalization, providing incorrect homonyms, or providing incorrect verb tenses.

14. The method of claim 10, wherein the other game functions include lose-a-turn, gain-a-turn, double-points and pick-a-question.

15. The method of claim 14, wherein if the player selects the pick-a-question function of the means for displaying and selecting, the player is asked a question or series of questions related to the document page;
if the player answers correctly, the player is awarded an immunity card, which allows the player to receive a second chance at answering an incorrectly answered question or placing an incorrectly placed game piece at a later time in the game;
if the player answers incorrectly, a subsequent player is given an opportunity to answer;
if the subsequent player is correct, the subsequent player is awarded the immunity card;
if none of the subsequent players is correct, the correct answer is revealed without awarding the immunity card to any of the players and another round of play is started.

16. The method of claim 10, wherein the educational game is a mathematical game or a science game.

17. The method of claim 10, further comprising determining a set period of time for game play in order to establish an end time.

18. The method of claim 10, further comprising determining a set period of time for each round of play.

19. The method of claim 10, wherein a high-speed round is played using a similar format to the game round but in which each player is provided with identical document pages and game pieces and each player simultaneously is instructed to correct as many errors as possible in the document page during a shortened period of time.

20. The method of claim 10, wherein the game is televised or transmitted over the Internet.

21. A computer readable medium encoded with a computer program for performing a method of playing an educational game, comprising:
creating a document page having a plurality of errors requiring correction to be displayed on a screen of an electronic device;
creating a plurality of game pieces, at least some of which are for correcting the plurality of errors in the document page;
providing an area for displaying the game pieces on the screen;
providing means for displaying and selecting available points or other game functions;
commencing game play by the player electronically engaging the means for determining and selecting in order to determine a number of points associated with a correct answer or to determine another game function;
if engaging the means for displaying and selecting results in the selection of the a number of points, the first player selects one of the game pieces and places the selected game piece on an area of the document page which the first player believes would be corrected by the selected game piece, wherein the placing of the game pieces is carried out using a mouse, a stylus, arrow keys or other data entry means;
if the player is correct, the player is awarded the number of points displayed;
if the player is not correct, the round ends, no points are awarded and another round of play is started;
if engaging the means for displaying and selecting results in the selection of the another game function, the player carries out the function selected;
commencing a subsequent round of play after the first round has ended using the same method as the first round of play;
continuing rounds of play until the player ends the game.
